(19) United States
(12) Patent Application Publication
(10) Pub. No.: US 2008/0279176 A1
(43) Pub. Date: Nov. 13, 2008

(54) BASE STATION SYSTEM AND MOBILE STATION SUPPORTING DTMF PROTOCOL

(76) Inventor: Jing-Ru Cheng, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/745,457

(22) Filed: May 8, 2007

(51) Int. Cl. H04L 12/66

(52) U.S. Cl. 370/352

(57) ABSTRACT

A protocol is proposed for a mobile station to transmit Dual Tone Multi-Frequency (DTMF) to another mobile station. When a user presses a key on a source mobile station, which is connected to a target mobile station, DTMF data are transmitted via a digital channel to a base station first. Instead of converting the received DTMF data to a corresponding analog voice to the target mobile station, the base station forwards the DTMF data to the target station via a digital channel. The target mobile station parses the DTMF data and activates certain operation in response to the key pressed by the user.

### FIELD OF THE INVENTION

The present invention relates to communication systems and more particularly relates to Digital Tone Multi-Frequency (DTMF) protocols in communication system.

### BACKGROUND OF THE INVENTION

Dual Tone Multi-Frequency (DTMF) signaling is originally used for telephone signaling over the line in the voice-frequency band to the call switching center. The version of DTMF used for telephone tone dialing is known by the trademarked term Touch-Tone, and is standardized by ITU-T Recommendation Q.23. Other multi-frequency systems are used for signaling internal to the telephone network.

Prior to DTMF, phone systems used a system known as pulse (Dial Pulse or DP in the USA) or loop disconnect (LD) signaling to dial numbers, which works by rapidly disconnecting and connecting the calling party's phone line, like flicking a light switch on and off. The repeated connection and disconnection, as the dial spins, sounds like a series of clicks. The exchange equipment counts those clicks or dial pulses to determine the called number. LD range was restricted by telegraphic distortion and other technical problems, and placing calls over longer distances required either operator assistance (operators used an earlier kind of multi-frequency dial) or the provision of subscriber trunk dialing equipment.

DTMF was developed at Bell Labs in order to allow dialing signals to dial long-distance numbers, potentially over non-wire links such as microwave radio relay links or satellites. For a few non crossbar offices, encoder/decoders were added that would convert the older pulse signals into DTMF tones and play them down the line to the remote end office. At the remote site another encoder/decoder could decode the tones and perform pulse dialing. It was as if you were connected directly to that end office, yet the signaling would work over any sort of link. This idea of using the existing network for signaling as well as the message is known as in-band signaling.

It was clear even in the late 1950s when DTMF was being developed that the future of switching lay in electronic switches, as opposed to the electromechanical crossbar systems then in use. Either switching system could use either dial system, but DTMF promised shorter holding times, which was more important in the larger and more complex registers used in crossbar systems. In this case pulse dialing made no sense at any point in the circuit, and plans were made to roll DTMF out to end users as soon as possible. Tests of the system occurred in the early 1960s, where DTMF became known as Touch Tone. Though Touch Tone phones were already in use in a few places, they were vigorously promoted at the 1964 New York World's Fair.

Today, there are various applications developed upon DTMF. For example, a user may press buttons of a telephone to operate an audio menu of a remote server which receives and analyzes DTMF signals to know what commands the user enters in the audio menu. Since such applications are widely used, mobile phones of GSM or 3 G need to support such functions.

In mobile phone applications like in GSM or 3 G, there are more than one channels established between a mobile phone and its base station. Taking GSM as an example, in addition to voice channel to transmit audio data, there is a digital channel, Fast Associated Control Channel (FACCH), established between a mobile phone and a base station. When a user presses a button on a mobile phone, corresponding DTMF data are transmitted from the mobile phone to a base station. In response to the received DTMF data, the base station generates corresponding analog sound and transmits the analog sound to a destination telephone device.

FIG. 1 illustrates such operation. A mobile station 101 sends DTMF START to a base station 102. The base station 102 generates a corresponding analog sound to a mobile station 103. Further, the base station 102 communicates with the mobile station 101 via a DTMF protocol as illustrated in FIG. 2A and FIG. 2B, which are digested from FIG. 5.8, TS24.008, V3.1.0 by 3GPP, 1999.

Such designs are applicable even if a receiving phone device is not a GSM mobile phone but a PSTN telephone device because the base station 102 sends analog sound. To decode which button a user presses in the mobile station 101, however, the mobile station 103 needs to be equipped with an DTMF audio recognition circuits, which are usually complicated. Moreover, when the analog sound is transmitted via a channel, the analog sound is easily interfered. That is, a user may press a button of ‘1’, but a receiver phone system may recognize it as ‘2’ if there is signal transmission error.

In telecommunication system, it is difficult to change requirements of a base station or a mobile phone, unless such changes do not cause significant cost. Therefore, it is advantageous to find an efficient way to solve DTMF problems as addressed above so that more convenient and reliable applications may be developed thereupon.

### BRIEF SUMMARY OF THE INVENTION

According to a first preferred embodiment, a base station system is provided for connecting communications between mobile stations. Each mobile station sends a DTMF via a digital channel to the base station system. The base station system includes a switching module for establishing a connection between a first mobile station and a second mobile station. The base station system also includes a network module for forwarding digital DTMF data received from the first mobile station to the second mobile station via the digital channel between the base station system and the second mobile station. In addition, the base station system also forwards digital DTMF data received from the second mobile station to the first mobile station via the digital channel between the base station system and the first mobile system.

According to a second embodiment of the invention, a mobile communication apparatus is provided. The mobile communication apparatus includes a network module and a processor. The network module is used for replying a DTMF acknowledgement to a source mobile station that issues DTMF data to the mobile communication apparatus. The network module is also used for parsing DTMF digits, which contain major information carried by DTMF signals. The processor activates a response action according to the parsed DTMF digit.

The mobile communication apparatus and the base station system are both designed based on a new proposed DTMF protocol. Under such DTMF protocol, there is fewer signal interference compared with transmitting DTMF analog sounds. Plus, when two mobile stations, e.g. mobile phones, as well as related base stations support such DTMF protocols, there are various new applications that can be developed over the mobile stations. Moreover, modification cost is not much while bringing significant improvements.

### BRIEF DESCRIPTION OF DRAWINGS

FIG. 1 is a diagram illustrating how DTMF signals are transmitted between two mobile stations in prior art;

FIG. 2A is a diagram illustrating a DTMF protocol of prior art when only a key is pressed;

FIG. 2B is a diagram illustrating a DTMF protocol of prior art when more than one keys are pressed;

FIG. 3 illustrates a GSM network on which embodiments according to the present invention are implemented;

FIG. 4 illustrates a DTMF protocol according to the invention;

FIG. 5 illustrates another DTMF protocol according to the invention;

FIG. 6 illustrates a flowchart of operating logic in a base station system; and

FIG. 7 illustrates a communication apparatus supporting the DTMF protocol according to the present invention.

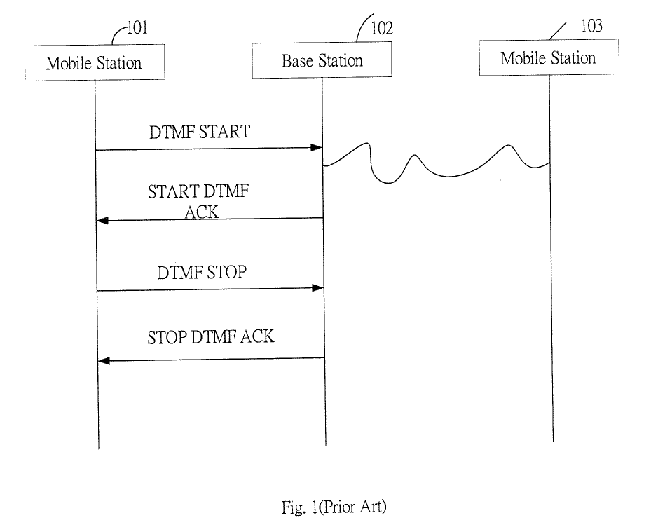

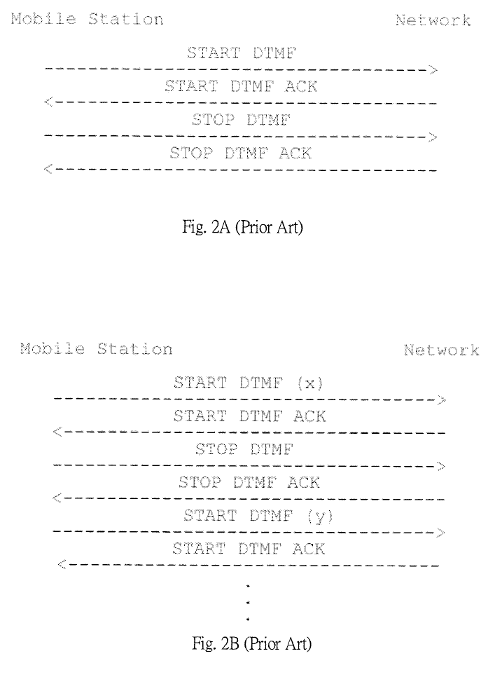

### DETAILED DESCRIPTION OF THE INVENTION

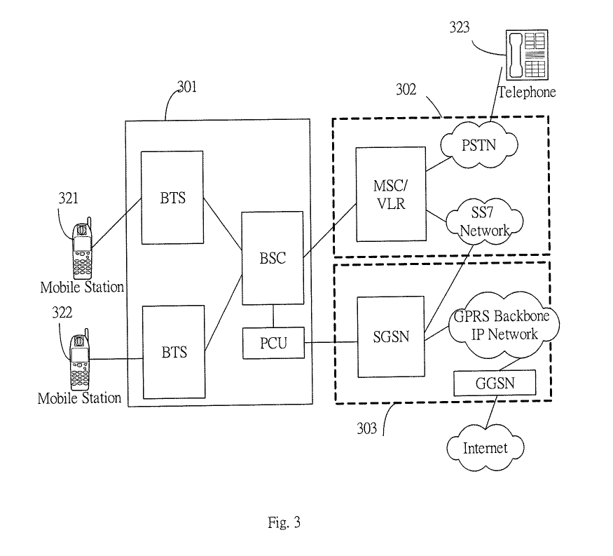

FIG. 3 illustrates a telecommunication network, taking Global System for Mobile Communication (GSM) as an example, upon which preferred embodiments of a base station system and a communication apparatus according to the invention are implemented. A mobile phone 321, a type of mobile stations, is connected to another mobile phone 322 via Base Transceiver Station (BTS), Base Station Controller (BSC) and another BTS in a GSM network. To connect the mobile phone 321 to a Public Switched Telephone Network (PSTN) telephone 323, data are routed from a Base Station Subsystem 301 to a Network and Switching Subsystem 302 via Mobile Switching Center (MSC) and PSTN network. If the mobile phone 321 is to be connected to Internet, data are transmitted to Packet Control Unit (PCU) to be forwarded to GPRS Core Network 303 via Serving GPRS Support Node (SGSN), GPRS Backbone IP Network and Gateway GPRS Support Node (GGSN). Usually, there are many and various machines connected for constructing a telecommunication network.

The term “base station system” is referred herein to hardware and/or software and/or their combination to form a portion or a whole of a communication system that handles DTMF protocols when connecting communications between mobile stations. For example, the term “base station system” may refer to software programs running on a BTS for implementing necessary network layer function that handles DTMF. For another example, the term “base station system” may refer to one or more than one machines which may further be accompanied with associated software for handling DTMF for its corresponding mobile stations.

Since the major inventive features include providing an improved way to handle DTMF, other portions except the DTMF function being modified can still be applied using various known technologies by persons skilled in the art. For the matter of simplicity, the technical parts persons skilled in the art know from published disclosure like 3GPP specifications are not repeated here. For example, persons skilled in the art know how to implement BTS and BSC and know where to implement DTMF functions, and such known portions are not particularly repeated here.

A base station system according to the invention includes a switching module for establishing connections among mobile stations. In addition, the base station system also includes a network module for handling DTMF data when two mobile stations are connected. The term “switching module” here refers to any hardware, software or their combination that serves a portion or a whole function to connect two mobile stations. For example, a “switching module” may refer to one or more than one machines that establish connections between two mobile stations. For another example, a “switching module” may refer to a portion of a server that implements a certain layer for connecting two mobile stations. When the switching module provides connection between two mobile stations, one or more than one channels are established between the connected mobile stations for data exchange. Taking GSM network as an example, there are several channels established between two mobile stations, in addition to the channel that transmits voice data. For example, Fast Associated Control Channel, which is a digital channel, is used in GSM network for passing DTMF data from a mobile station to a base station server. With such digital channel existed between two mobile stations, the network module of the base station forwards digital DTMF data received from a mobile station to another mobile station and vice versa. Under such modification to the base station server, instead of sending analog sounds to receiver mobile station, digital DTMF data are transmitted and there is fewer interference and there is no need to design a complicated audio recognition circuit in a receiver mobile station to analyze received DTMF information.

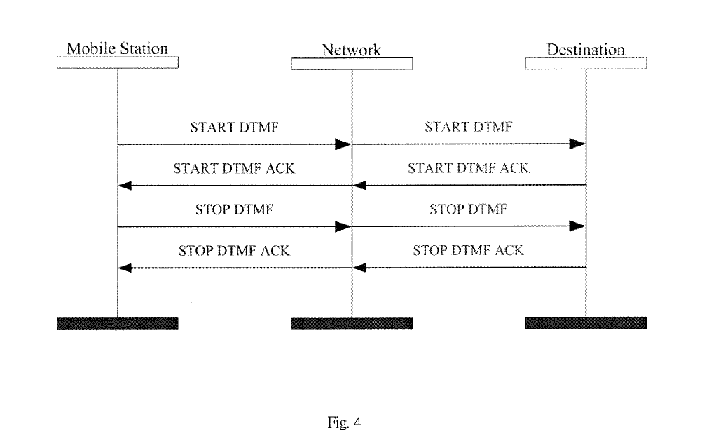

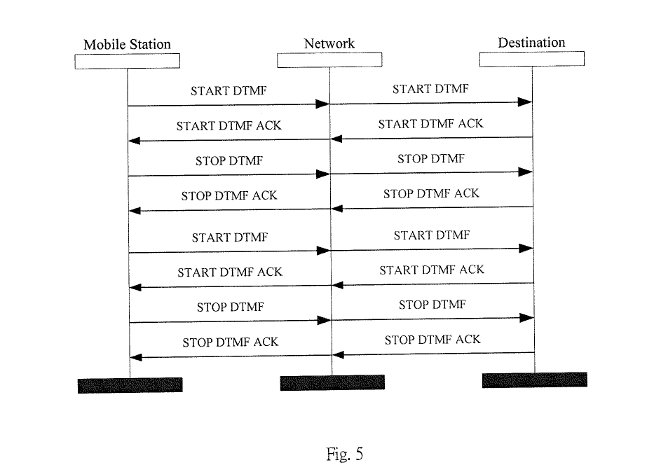

FIG. 4 and FIG. 5 illustrate such novel DTMF protocols proposed in this invention. It is important to note that the base station server does not always generate analog sound according to DTMF data received from a mobile station. Instead, the base station server forwards DTMF data received from one mobile station to another mobile station if necessary or being configured to do so. The term “forward” is not limited to simple passing received data without any conversion. For example, the term “forward” may include cases that the base station server generates another DTMF data value according to received DTMF data.

In FIG. 4, when a user presses a button, e.g. “1”, of a mobile phone, the mobile phone generates START DTMF signal with DTMF digit, i.e. “1”, to a base station server, marked as “Network” via FACCH. Please be noted that FACCH is listed here just for an example. In different telecommunication standards, the FACCH listed here may be substituted with other channels. The base station server, instead of generating an analog frequency of “1”, forwards the DTMF data received from the sender mobile phone to a receiver mobile phone. It is possible that the receiver mobile phone does not recognize START DTMF. When such case happens, the base station generates a traditional analog DTMF sound to the receiver mobile phone. Alternatively, the base station may wait for certain time and if the base station cannot receive any START DTMF ACK, the base station may know the receiver mobile station does not support the novel DTMF function. Then, the base station may report such status back to the sender mobile station. If the receiver mobile phone supports such novel DTMF function, the receiver mobile phone issues START DTMF ACK back to the base station, and the base station forwards the START DTMF ACK back to the sender mobile phone. The operation can be extended to the diagram in FIG. 5, which illustrates the case when multiple keys are pressed during a session. Under such design, it is not necessary to significantly change architecture of the base station or the receiver mobile phone while preventing drawbacks of traditional designs. Such advantages are not taught in prior art. Even more, such problems are not noticed before the invention.

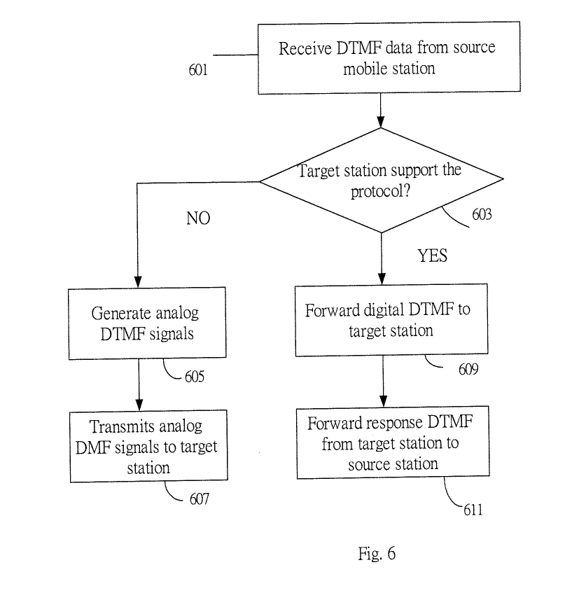

FIG. 6 is a flowchart illustrating how to implement a base station server according to the invention. Since the modification of this embodiment mainly relies on DTMF handling, other portions of implementation of a base station server should be known and are not repeated here. Such flowchart can be implemented into corresponding hardware circuits, software programs and/or their combinations. First, DTMF data are received at the base station server from a source (mobile) station (step 601). The base station server checks whether a target (mobile) station supports the DTMF designs as explained above (step 603). If the base station server detects that the target station does not support such protocol, the base station server generates analog DTMF signals (step 605) and then transmits the analog DTMF signals to the target station (step 607). Otherwise, the base station server forwards digital DTMF signals to the target station (step 609). If the target station returns back any DTMF signals, such DTMF signals are forwarded back to the source station by the base station server.

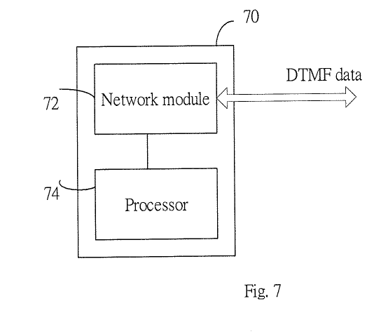

FIG. 7 illustrates a diagram of another embodiment according to the present invention, which is a mobile communication apparatus 70 that complies with the proposed DTMF protocol. The mobile communication apparatus 70 includes a network module 72 and a processor 74. An example for the network module is a DTMF module that is responsible for processing DTMF. An example of such mobile communication apparatus 70 is a mobile phone, e.g. a GSM mobile phone. In such case, the network module 72 is used for generating DTMF signals, transmitting DTMF signals via a digital channel to a base station server that supports the above mentioned DTMF protocol, and parsing DTMF signals received from the base station server. One of such DTMF signals include DTMF digit, which corresponds to an event indicating a key being pressed or a program generated data to be sent to another mobile station.

In addition to the network module 72, the processor 74 activates a response action according received DTMF digit. There are various response actions can be designed under such architecture. For example, any audio menu responding systems as widely seen today can be implemented in such mobile communication apparatus 70. In addition, the DTMF channel between the mobile communication apparatus 70 and another mobile station may be used for transmitting any kinds of information. That is, in addition to keys pressed by users, the DTMF data may include any types of information to be exchanged between two mobile stations. Examples of applications may include, but not limited to, transmitting text message, URLs pointing to certain network resources, commands to control remote mobile stations, etc.

Except new DTMF functions as recited above, other portions of the network module 72 and the processor 74 can be implemented with various ways as known by persons skilled in the art. That means any combination of hardware circuits, software programs and/or their combinations.

While the invention has been described with respect to a limited number of embodiments, it will be appreciated that many variations, modifications and other applications of the invention may be made.

What is claimed is:

1. A base station system used for connecting communications between mobile stations, each mobile station sending a Dual Tone Multi-Frequency (DTMF) via a digital channel to the base station system, comprising:
a switching module for establishing a connection between a first mobile station and a second mobile station; and
a network module for forwarding digital DTMF data received from the first mobile station to the second mobile station via the digital channel between the base station system and the second mobile station and for forwarding digital DTMF data received from the second mobile station to the first mobile station via the digital channel between the base station system and the first mobile station.

2. The base station system of claim 1, wherein the base station complies with GSM standards and the digital channel is Fast Associated Control Channel (FACCH).

3. The base station system of claim 1, wherein the type of the DTMF data comprises: a start of DTMF, an acknowledgement of receiving DTMF and a DTMF digit.

4. The base station system of claim 3, wherein the type of the DTMF data further comprises: a stop of DTMF, an acknowledgement of stop DTMF, and a rejection of DTMF.

5. The base station system of claim 1, wherein the network module returns a rejection of DTMF to the first mobile station if the network module detects the second mobile station not capable of interpreting the DTMF data received from the digital channel between the base station system and the second mobile station.

6. The base station system of claim 1, wherein the network module forwards an analog DTMF signal to the second mobile station if the network module detects the second mobile station not capable of interpreting the DTMF data received from the digital channel between the base station and the second mobile station.

7. A mobile communication apparatus capable of interpreting Digital Tone of Multi-Frequency (DTMF) data received from a base station system via a digital channel, the DTMF data being originally transmitted from a source mobile station, comprising:
a network module for replying a DTMF acknowledgement back to the source mobile station and for parsing the DTMF data received from the digital channel, the DTMF data comprising a DTMF digit; and
a processor for activating a response action according to the DTMF digit.

8. The mobile communication apparatus of claim 7, wherein the processor provides an audio menu to a user of the source mobile station and the audio menu is operated according to the DTMF data.

9. The mobile communication apparatus of claim 7, wherein the processor generates response DTMF data to be transmitted to the source mobile station.

10. The mobile communication apparatus of claim 7, wherein the mobile station complies with GSM standards and the digital channel is Fast Associated Control Channel (FACCH).

11. The mobile communication apparatus of claim 7, wherein the type of the DTMF data comprises: a start of DTMF, an acknowledgement of receiving DTMF and a DTMF digit.

12. The mobile communication apparatus of claim 7, wherein the type of the DTMF data further comprises: a stop of DTMF, an acknowledgement of stop DTMF and a rejection of DTMF.
